(19) United States
(12) Patent Application Publication
(10) Pub. No.: US 2012/0080590 A1
(43) Pub. Date: Apr. 5, 2012

(54) METHODS OF DETERMINING PLANT ZYGOSITY USING MASS SPECTROMETRY

(75) Inventor: Shib Sankar Basu, Durham, NC (US)

(73) Assignee: Syngenta Participations AG

(21) Appl. No.: 12/897,273

(22) Filed: Oct. 4, 2010

(51) Int. Cl. H01J 49/00

(52) U.S. Cl. 250/282; 250/281

(57) ABSTRACT

The present invention relates to methods and systems for identifying seeds that are homozygous for an allele of interest and/or for identifying seeds that are likely to produce plants possessing a desired trait. Methods of producing plants that are homozygous for an allele of interest and/or that possess a desired trait are also provided.

### FIELD OF THE INVENTION

The present invention relates to methods of identifying seeds that are homozygous for an allele of interest and methods of identifying seeds that are likely to produce plants possessing a desired trait.

### BACKGROUND

It is conventional practice in plant breeding or plant advancement experiments to grow plants from seeds of known parentage. The seeds are planted in experimental plots, growth chambers, greenhouses, or under other growing conditions in which they are either cross pollinated with other plants of known parentage or self pollinated. The resultant seeds are the offspring of the two parent plants or the self-pollinated plant, and are harvested, processed and planted to continue the plant breeding cycle. Specific laboratory or field-based tests may be performed on the plants, plant tissues, seed and/or seed tissues, in order to aid in the breeding or advancement selection process.

Generations of plants based on known crosses or self-pollinations are planted and then tested to see if they possess characteristics that are desirable in the marketplace. Examples of desirable traits include, but are not limited to, increased yield, increased homozygosity, improved or newly-conferred resistance and/or tolerance to specific herbicides and/or pests and/or pathogens, increased oil content, altered starch content, nutraceutical composition, drought tolerance, and specific morphology-based trait enhancements.

As can be appreciated, and as is well known in the art, these experiments can be massive in scale. A huge labor force is required to design experiments, plant seeds, maintain plants and otherwise conduct the experiments, which can involve thousands or tens of thousands of individual plants. Such experiments also require substantial land resources—one experiment may occupy thousands of acres of land for months while the plants germinate, grow and produce seed. Then, the massive amounts of seed must be individually tagged, harvested and processed.

A further complication is that much of the experimentation goes for naught. It has been reported in the literature that some seed companies discard 80-90% of the plants in any generation early on in the experiment. Thus, much of the land, labor and material resources expended for growing, harvesting, and post-harvest processing ultimately are wasted for a large percentage of the seed.

Timing pressures are also a factor. Significant advances in plant breeding have put more pressure on seed companies to more quickly advance lines or varieties of plants for more and better traits and characteristics. The plant breeders and associated workers are thus under increasing pressure to more efficiently and effectively process these generations and to make more and earlier selections of plants which should be continued into the next generation of breeding.

Therefore, a movement towards earlier identification of traits of interest through laboratory-based seed testing has emerged. Such testing generally involves removing a tissue sample from the seed such that the seed remains viable following removal of the tissue sample. Testing the seeds themselves obviates the need to grow the seeds into immature plants before testing, which saves time, space and effort. Moreover, testing the seeds prior to planting allows for the elimination of lines lacking the desirable trait(s). That is, one may select and plant only those seeds which comprise the desirable trait(s), eliminating the waste that occurs when seeds lacking the desirable trait(s) are grown into immature plants before they are identified and discarded. In summary, early identification of a desirable trait in a given subpopulation of seeds may reduce the amount of land needed for experimental testing, the amount of seeds/plants that must be tested and the amount of time needed to identify seeds/plants with the desirable trait.

Conventional seed-testing technologies have been aimed at determining the genetic makeup of a seed using traditional genetic testing. Although such technologies have proven useful for identifying seeds that comprise a given gene, they are limited in the amount and types of information they can provide. Because each test is necessarily focused on a single gene of interest, multiple tests must be run if one wishes to investigate multiple genes. Moreover, such testing merely elucidates whether a given seed comprises the gene of interest—the tests cannot determine whether the seeds actually express the desired gene product. Nor can conventional genetic testing be used to determine whether the seeds express any particular protein form.

The present invention overcomes many of the shortcomings in the art by providing methods of identifying seeds that are homozygous for an allele of interest using mass spectrometry to quantify the amount of a protein of interest in a sample derived from a portion of endosperm that has been removed from the seeds. The present invention also provides methods for producing plants that are homozygous for an allele of interest. Systems for carrying out the methods of the present invention are also provided.

The present invention is explained in greater detail below. This description is not intended to be a detailed catalog of all the different ways in which the invention may be implemented, or all the features that may be added to the instant invention. For example, features illustrated with respect to one embodiment may be incorporated into other embodiments and features illustrated with respect to a particular embodiment may likewise be deleted from that embodiment. In addition, numerous variations and additions to the various embodiments suggested herein, which do not depart from the instant invention, will be apparent to those skilled in the art in light of the instant disclosure. Hence, the following specification is intended to illustrate some particular embodiments of the invention and not to exhaustively specify all permutations, combinations and variations thereof.

### SUMMARY OF THE INVENTION

Methods for identifying seeds that are homozygous for an allele of interest are provided. Methods for producing plants that are homozygous for an allele of interest are also provided. Methods for identifying seeds that are likely to produce plants possessing a desired trait are also provided. Methods for producing plants possessing a desired trait are also provided. Such methods may be used to enhance the efficiency of plant development and improvement techniques including, but not limited to, traditional breeding, marker-assisted selection, and transformation.

In some embodiments, methods of identifying a seed that is homozygous for an allele of interest are provided. Such methods may comprise, consist essentially of or consist of:
1) removing a portion of endosperm from a seed;
2) quantifying a protein of interest in a sample derived from the portion of endosperm using mass spectrometry; and
3) determining that the seed is homozygous for the allele of interest.

In some embodiments, methods of producing a plant that is homozygous for an allele of interest are provided. Such methods may comprise, consist essentially of or consist of:
1) removing a portion of endosperm from a seed;
2) quantifying a protein of interest in a sample derived from the portion of endosperm using mass spectrometry;
3) determining that the seed is homozygous for the allele of interest; and
4) growing a plant from the seed.

In some embodiments, the seed is derived from crossing a first plant or germplasm comprising the allele of interest with a second plant or germplasm comprising the allele of interest. In some such embodiments, the first plant or germplasm is homozygous for the allele of interest and the second plant or germplasm is heterozygous for the allele of interest, while in other such embodiments, the first plant or germplasm is heterozygous for the allele of interest and the second plant or germplasm is homozygous for the allele of interest. In still further such embodiments, both the first plant or germplasm and the second plant or germplasm are heterozygous for the allele of interest.

In some embodiments, the seed is derived from a plant that has been transformed with the allele of interest.

In some embodiments, quantifying a protein of interest in a sample derived from the portion of endosperm using mass spectrometry comprises comparing the relative intensity of a peak associated with a peptide of interest to that of a peak associated with a known amount of a standard. In some embodiments, the standard may be an isotope-labeled peptide that is chemically identical to the peptide of interest. In some embodiments, the standard may be an unrelated molecule (e.g. cortisol).

In some embodiments, quantifying a protein of interest in a sample derived from the portion of endosperm using mass spectrometry comprises a relative quantification of a peak associated with a peptide of interest. In some such embodiments, the intensity of a peak associated with a peptide of interest in a sample derived from a first seed is compared to that of the equivalent peak in a sample derived from another seed without the use of any standard or internal reference.

In some embodiments, quantifying a protein of interest in a sample derived from the portion of endosperm using mass spectrometry comprises a relative quantification of a peak associated with a peptide of interest. In some such embodiments, the intensity of a peak associated with a peptide of interest in a sample derived from a first seed is compared to that of equivalent peaks in samples derived from a number of other seeds without the use of any standard or internal reference.

In some embodiments, determining that a seed is homozygous for an allele of interest may comprise, consist essentially of or consist of determining that the amount of a protein of interest in a sample derived from a portion of endosperm removed from a first seed is at least about twice that of a sample derived from a portion of endosperm removed from a second seed. Some such embodiments further comprise determining that the second seed is heterozygous for the allele of interest.

In some embodiments, determining that a seed is homozygous for an allele of interest may comprise, consist essentially of or consist of determining that the amount of a protein of interest in a sample derived from a portion of endosperm removed from a first seed is at least about twice that of a sample derived from a portion of endosperm removed from a second seed and determining that a sample derived from a portion of endosperm removed from a third seed contains no detectable amount of the protein of interest. Some such embodiments further comprise determining that the second seed is heterozygous for the allele of interest, determining that the third seed does not comprise the allele of interest and/or determining that the third seed does not comprise a functional allele of interest (i.e., the allele of interest, if present, is not functional in so far as it does not result in a detectable amount of the protein of interest).

In some embodiments, determining that a seed is homozygous for an allele of interest may comprise, consist essentially of or consist of determining that the seed contains no detectable amount of a protein of interest. In some such embodiments, at least one of the desired traits associated with the allele of interest is a reduction or elimination of the protein of interest.

In some embodiments, determining that a seed is homozygous for an allele of interest may comprise, consist essentially of or consist of comparing the amount of a protein of interest in a sample derived from a portion of endosperm that has been removed from a first seed with a reference value or values. In some such embodiments, the reference value(s) may be associated with or obtained from a sample derived from a portion of endosperm removed from a seed that is homozygous for the allele of interest, a sample derived from a portion of endosperm removed from a seed that is heterozygous for the allele of interest, a sample derived from a portion of endosperm removed from a seed that does not comprise the allele of interest and/or a sample derived from a portion of endosperm removed from a seed that does not comprise a functional allele of interest.

In some embodiments, systems for identifying a seed that is homozygous for an allele of interest are provided. Such systems may comprise, consist essentially of or consist of
1) a means for removing a portion of endosperm from a seed; and
2) a means for quantifying a protein of interest in a sample derived from the portion of endosperm using mass spectrometry.

In some embodiments, methods of identifying a seed that is likely to produce a plant that possesses a desired trait are provided. Such methods may comprise, consist essentially of or consist of:
1) removing a portion of endosperm from a seed;
2) quantifying a protein of interest in a sample derived from the portion of endosperm using mass spectrometry; and
3) determining that the seed is likely to produce a plant that possesses the desired trait.

In some embodiments, methods of producing a plant that possesses a desired trait are provided. Such methods may comprise, consist essentially of or consist of:
1) removing a portion of endosperm from a seed;
2) quantifying a protein of interest in a sample derived from the portion of endosperm using mass spectrometry;
3) determining that the seed is likely to produce a plant that possesses the desired trait; and
4) growing a plant from the seed.

In some embodiments, the seed is derived from crossing a first plant or germplasm possessing the desired trait with a second plant or germplasm lacking the desired trait.

In some embodiments, the seed is derived from a plant that has been transformed with an allele associated with the desired trait.

In some embodiments, quantifying a protein of interest in a sample derived from the portion of endosperm using mass spectrometry comprises comparing the relative intensity of a peak associated with a peptide of interest to that of a peak associated with a known amount of a standard. In some embodiments, the standard may be an isotope-labeled peptide that is chemically identical to the peptide of interest. In some embodiments, the standard may be an unrelated molecule (e.g. cortisol).

In some embodiments, quantifying a protein of interest in a sample derived from the portion of endosperm using mass spectrometry comprises a relative quantification of a peak associated with a peptide of interest. In some such embodiments, the intensity of a peak associated with a peptide of interest in a sample derived from a first seed is compared to that of the equivalent peak in a sample derived from another seed without the use of any standard or internal reference.

In some embodiments, quantifying a protein of interest in a sample derived from the portion of endosperm using mass spectrometry comprises a relative quantification of a peak associated with a peptide of interest. In some such embodiments, the intensity of a peak associated with a peptide of interest in a sample derived from a first seed is compared to that of equivalent peaks in samples derived from a number of other seeds without the use of any standard or internal reference.

In some embodiments, determining that a seed is likely to produce a plant possessing a desired trait may comprise, consist essentially of or consist of determining that the amount of a protein of interest in a sample derived from a portion of endosperm removed from a first seed is greater than the amount of the protein of interest in a sample derived from a portion of endosperm removed from a second seed. In some such embodiments, the amount of the protein of interest in the sample derived from the portion of endosperm removed from the first seed is at least about twice that of the sample derived from the portion of endosperm removed from the second seed. Some such embodiments further comprise determining that the second seed is likely to produce a plant lacking the desired trait.

In some embodiments, determining that a seed is likely to produce a plant possessing a desired trait may comprise, consist essentially of or consist of determining that the amount of a protein of interest in a sample derived from a portion of endosperm removed from a first seed is less than the amount of the protein of interest in a sample derived from a portion of endosperm removed from a second seed. In some such embodiments, the amount of the protein of interest in the sample derived from the portion of endosperm removed from the first seed is at least about half that of the sample derived from the portion of endosperm removed from the second seed. Some such embodiments further comprise determining that the second seed is likely to produce a plant possessing the desired trait.

In some embodiments, determining that a seed is likely to produce a plant possessing a desired trait may comprise, consist essentially of or consist of determining that a sample derived from a portion of endosperm removed from the seed contains no detectable amount of a protein of interest. In some such embodiments, at least one of the desired traits is associated with a reduction or elimination of the protein of interest.

In some embodiments, determining that a seed is likely to produce a plant that possesses a desired trait may comprise, consist essentially of or consist of comparing the amount of a protein of interest in a sample derived from a portion of endosperm removed from a first seed with a reference value or values. In some such embodiments, the reference value(s) may be associated with or obtained from a sample derived from a portion of endosperm removed from a seed that produced a plant possessing the desired trait, a sample derived from a portion of endosperm removed from a seed that produced a plant lacking the desired trait, the average amount of the protein of interest in samples derived from portions of endosperm removed from seeds that produced plants possessing the desired trait and/or the average amount of the protein of interest in samples derived from portions of endosperm removed from seeds that produced plants lacking the desired trait.

In some embodiments, systems for identifying a seed that is likely to produce a plant possessing a desired trait are provided. Such systems may comprise, consist essentially of or consist of:
1) a means for removing a portion of endosperm from a seed; and
2) a means for quantifying a protein of interest in a sample derived from the portion of endosperm using mass spectrometry.

The foregoing and other objects and aspects of the present invention are explained in detail in the drawings and specification set forth below.

### DETAILED DESCRIPTION

The present invention provides methods of identifying and producing plants from seeds that are homozygous for an allele of interest. Systems for identifying seeds that are homozygous for an allele of interest are also provided. Methods of identifying seeds that are likely to produce plants possessing a desired trait are also provided.

Unlike conventional seed chipping technologies, which rely on genetic testing to establish whether a seed comprises an allele of interest and/or whether a seed is homozygous or heterozygous for an allele of interest, the methods/systems of the present invention allow one skilled in the art to simultaneously determine the genotypic status of one or more alleles of interest in a single sample using mass spectrometry. Moreover, the methods/systems of the present invention allow one skilled in the art to ascertain, from a single sample, using mass spectrometry, whether one or more alleles of interest are actually expressed in the seed and/or whether one or more proteins of interest exist as particular conformational isomers.

The methods of the present invention may be carried out using automated, high-throughput systems, which allow one skilled in the art to process high volumes of seeds in a more efficient and cost-effective manner than previous technologies. See, e.g., U.S. Pat. No. 7,591,101 (describing an automated seed sampler).

The methods/systems of the present invention may be used in conjunction with traditional breeding programs, marker-assisted selection programs and/or plant transformation programs. Notably, the methods/systems of the present invention may be used to simultaneously monitor and identify multiple recombination events and/or transformation events.

### Definitions

Although the following terms are believed to be well understood by one of ordinary skill in the art, the following definitions are set forth to facilitate understanding of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art.

All patents, patent publications and non-patent publications referenced herein are incorporated by reference in their entireties.

As used herein, the terms “a” or “an” or “the” may refer to one or more than one. For example, “a” marker can mean one marker or a plurality of markers. Likewise, “an” allele of interest can mean one allele of interest of a plurality of alleles of interest.

As used herein, the term “and/or” refers to and encompasses any and all possible combinations of one or more of the associated listed items, as well as the lack of combinations when interpreted in the alternative (“or”).

As used herein, the term “about,” when used in reference to a measurable value such as an amount of mass, dose, time, temperature, and the like, is meant to encompass variations of 20%, 10%, 5%, 1%, 0.5%, or even 0.1% of the specified amount.

As used herein, the term “allele” refers to one of two or more different nucleotides or nucleotide sequences that occur at a specific locus.

As used herein, the terms “backcross and “backcrossing” refer to the process whereby a progeny plant is repeatedly crossed back to one of its parents. In a backcrossing scheme, the “donor” parent refers to the parental plant with the desired gene or locus or allele to be introgressed. The “recipient” parent (used one or more times) or “recurrent” parent (used two or more times) refers to the parental plant into which the gene or locus or allele is being introgressed. For example, see Ragot, M. et al. Marker-assisted Backcrossing: A Practical Example, in TECHNIQUES ET UTILISATIONS DES MARQUEURS MOLECULAIRES LES COLLOQUES, Vol. 72, pp. 45-56 (1995); and Openshaw et al., Marker-assisted Selection in Backcross Breeding, in PROCEEDINGS OF THE SYMPOSIUM “ANALYSIS OF MOLECULAR MARKER DATA,” pp. 41-43 (1994). The initial cross gives rise to the F1 generation. The term “BC1” refers to the second use of the recurrent parent, “BC2” refers to the third use of the recurrent parent, and so on.

As used herein, the terms “cross” or “crossed” refer to the fusion of gametes via pollination to produce progeny (e.g., cells, seeds or plants). The term encompasses both sexual crosses (the pollination of one plant by another) and selfing (self-pollination, e.g., when the pollen and ovule are from the same plant). The term “crossing” refers to the act of fusing gametes via pollination to produce progeny.

As used herein, the terms “cultivar” and “variety” refer to a group of similar plants that by structural and/or genetic features and/or phenotypic traits and/or performance can be distinguished from other varieties within the same species.

As used herein, the terms “desired allele” and “allele of interest” are used interchangeably to refer to an allele associated with a desired trait. An “allele of interest” and/or “desired allele” may be associated with either an increase or a decrease of or in a given trait, as well as the presence or absence of a given trait, depending on the nature of the desired phenotype.

As used herein, the terms “desired trait” and “trait of interest” are used interchangeably to refer to an increase or a decrease of or in a given trait, as well as the presence or absence of a given trait, depending on the nature of the desired phenotype. In some embodiments, a desired trait may be associated with the presence or absence of a protein of interest. In some embodiments, a desired trait may be associated with enhanced or reduced production of a protein of interest.

As used herein, the terms “elite” and “elite line” refer to any line that is substantially homozygous and has resulted from breeding and selection for desirable agronomic performance.

As used herein, the term “fragmented peptide” refers to a peptide produced when a protein of interest is subjected to fragmentation using a technique such as electron transfer dissociation (ETD), electron capture dissociation (ECD), collision-induced dissociation (CID) or infrared multiphoton dissociation (IRMPD).

As used herein, the term “genotype” refers to the genetic constitution of an individual (or group of individuals) at one or more genetic loci, as contrasted with the observable and/or detectable and/or manifested trait (the phenotype). Genotype is defined by the allele(s) of one or more known loci that the individual has inherited from its parents. The term genotype can be used to refer to an individual's genetic constitution at a single locus, at multiple loci, or more generally, the term genotype can be used to refer to an individual's genetic make-up for all the genes in its genome. Genotypes can be indirectly characterized, e.g., using markers and/or directly characterized by nucleic acid sequencing.

As used herein, the term “germplasm” refers to genetic material of or from an individual (e.g., a plant), a group of individuals (e.g., a plant line, species, variety or family), or a clone derived from a line, variety, species, or culture. The germplasm can be part of an organism or cell, or can be separate from the organism or cell. In general, germplasm provides genetic material with a specific molecular makeup that provides a physical foundation for some or all of the hereditary qualities of an organism or cell culture. As used herein, germplasm includes cells, seed or tissues from which new plants may be grown, as well as plant parts, such as leafs, stems, pollen, or cells that can be cultured into a whole plant.

A “haplotype” is the genotype of an individual at a plurality of genetic loci, i.e., a combination of alleles. Typically, the genetic loci described by a haplotype are physically and genetically linked, i.e., on the same chromosome segment. The term “haplotype” can refer to polymorphisms at a particular locus, such as a single marker locus, or polymorphisms at multiple loci along a chromosomal segment.

A “heterotic group” comprises a set of genotypes that perform well when crossed with genotypes from a different heterotic group. Hanauer et al., Corn breeding, in Corn and Corn Improvement p. 463-564 (1998). Inbred lines are classified into heterotic groups, and are further subdivided into families within a heterotic group, based on several criteria such as pedigree, molecular marker-based associations, and performance in hybrid combinations. Smith et al., Theor. Appl. Gen. 80:833 (1990).

As used herein, the term “heterozygous” refers to a genetic status wherein different alleles reside at corresponding loci on homologous chromosomes.

As used herein, the term “homozygous” refers to a genetic status wherein identical alleles reside at corresponding loci on homologous chromosomes.

As used herein, the term “hybrid” refers to a seed and/or plant produced when at least two genetically dissimilar parents are crossed.

As used herein, the term “inbred” refers to a substantially homozygous plant or variety. The term may refer to a plant or variety that is substantially homozygous throughout the entire genome or that is substantially homozygous with respect to a portion of the genome that is of particular interest.

As used herein, the term “ionized peptide” refers to a peptide that is produced when a peptide belonging to a protein of interest is subjected to ionization using a technique such as electrospray ionization (ESI), Matrix Assisted Laser Desorption Ionisation (MALDI), fast atom bombardment (FAB) or atmospheric pressure chemical ionization (APCI).

A seed is “likely to produce a plant possessing a desired trait” if there is more than a 50% chance that the seed will produce a plant possessing the desired trait. In some embodiments, there is about a 99%, 95%, 90%, 85%, 80%, 75%, 70%, 65%, 60% or 55% chance that the seed will produce a plant possessing the desired trait.

A “locus” is a position on a chromosome where a gene or marker or allele is located. In some embodiments, a locus may encompass one or more nucleotides.

As used herein, the term “maize” refers to a plant of the Zea mays L. ssp. mays and is also known as “corn.”

As used herein, the term “maize plant” includes whole maize plants, maize plant cells, maize plant protoplast, maize plant cell or maize tissue cultures from which maize plants can be regenerated, maize plant calli, and maize plant cells that are intact in maize plants or parts of maize plants, such as maize seeds, maize cobs, maize flowers, maize cotyledons, maize leaves, maize stems, maize buds, maize roots, maize root tips, and the like.

As used herein, the term “peptide of interest” refers to a peptide belonging to a protein of interest. In some cases, a “peptide of interest” may comprise or be a “proteolytic peptide,” an “ionized peptide” or a “fragmented peptide.”

As used herein, the terms “phenotype,” “phenotypic trait” or “trait” refer to one or more traits of an organism. The phenotype can be observable to the naked eye, or by any other means of evaluation known in the art, e.g., microscopy, biochemical analysis, or an electromechanical assay. In some cases, a phenotype is directly controlled by a single gene or genetic locus, i.e., a “single gene trait.” In other cases, a phenotype is the result of several genes. It is noted that, as used herein, the term “water optimization phenotype” takes into account environmental conditions that might affect water optimization such that the water optimization effect is real and reproducible.

As used herein, the term “plant” may refer to a whole plant, any part thereof, or a cell or tissue culture derived from a plant. Thus, the term “plant” can refer to any of: whole plants, plant components or organs (e.g., leaves, stems, roots, etc.), plant tissues, seeds and/or plant cells. A plant cell is a cell of a plant, taken from a plant, or derived through culture from a cell taken from a plant.

As used herein, the term “population” refers to a genetically heterogeneous collection of plants sharing a common genetic derivation.

As used herein, the terms “progeny” and “progeny plant” refer to a plant or germplasm generated from a vegetative or sexual reproduction from one or more parent plants. A progeny plant may be obtained by cloning or selfing a single parent plant, or by crossing two parental plants.

As used herein, the term “protein of interest” refers to a protein encoded by an allele of interest or by a nucleotide sequence comprising the allele of interest.

As used herein, the term “proteolytic peptide” refers to a peptide that is produced when a protein of interest is enzymatically digested.

As used herein, the term “reference value” refers to a value derived from the amount of a protein of interest in one or more samples derived from a reference seed or reference seeds. In some embodiments, the zygosity of the reference seed(s) with regards to the allele of interest that encodes the protein of interest is known. In some embodiments, it is known whether the seed(s) produced or will produce a plant or plants possessing a desired trait. For example, a reference value may be derived from the amount of a protein of interest in a sample derived from a portion of endosperm removed from a reference seed that is known to be homozygous for an allele of interest and/or that is known to have produced a plant that possess(es/ed) a desired trait. Similarly, a reference value may be derived from the average amount of a protein of interest in samples derived from portions of endosperm removed from reference seeds that are known to be homozygous for an allele of interest and/or that are known to have produced plants that possess(ed) a desired trait.

As used herein, the terms “sample” and “sample derived from [a/the] portion of endosperm” are used interchangeably to refer to a specimen derived from a portion of endosperm that has been removed from a seed. The specimen may consist of any part of the portion of endosperm removed from the seed, or may comprise the entirety of the portion of endosperm removed from the seed. The specimen may be in its native form, or it may have been physically/chemically treated in preparation for analysis, testing or investigation.

The “Stiff Stalk” heterotic group represents a major heterotic group in the northern U.S. and Canadian corn growing regions. It can also be referred to as the “Iowa Stiff Stalk Synthetic” or “BSSS” heterotic group.

As used herein, the term “transgene” refers to a nucleic acid molecule comprising a nucleotide sequence (e.g., a nucleotide sequence encoding a protein and/or other functional gene product) that is introduced into a cell as a heterologous or exogenous nucleotide sequence. In some embodiments, the transgene can be a nucleic acid molecule comprising a nucleotide sequence from one organism that is introduced into a cell of another and/or different organism. The nucleic acid molecule can be transiently expressed in the cell of the organism and/or stably integrated into the genome of the cell of the organism. In some embodiments, a gene or coding sequence from one plant is introduced as a transgene into the genome of another plant.

As used herein, the term “transformation,” “transforming,” or “transformed” refers to the introduction of one or more exogenous or heterologous nucleic acid molecules (e.g., a transgene or coding sequence) into a cell. Transformation of a cell may be stable or transient.

“Transient transformation” in the context of a polynucleotide means that a polynucleotide is introduced into the cell and does not integrate into the genome of the cell.

“Stable transformation” or “stably transformed” as used herein means that a nucleic acid is introduced into a cell and integrates into the genome of the cell. As such, the integrated nucleic acid is capable of being inherited by the progeny thereof, more particularly, by the progeny of multiple successive generations. “Genome” as used herein also includes the nuclear and the plastid genome, and therefore includes integration of the nucleic acid into, for example, the chloroplast genome. Stable transformation as used herein can also refer to a transgene that is maintained extrachromosomally, for example, as a minichromosome.

Methods of introducing an exogenous or heterologous nucleic acid sequence into a plant are well known and include the direct infection or co-cultivation of plant cells with Agrobacterium tumefaciens (Horsch et al. Science 227:1229 (1985)) and microprojectile bombardment using gold particles coated with nucleic acid comprising a transgene.

An “undesired allele” is an allele that is associated with an undesired trait. Seeds and/or plants comprising an undesired allele may be identified and removed from a breeding program or planting.

### Seed Chipping

The present invention provides methods of removing a portion of endosperm from a seed. The portion of endosperm may be removed by any present or future method known in the art, including, but not limited to, removing a portion of endosperm with a sharp blade, drilling a small hole in the seed and collecting the resultant powder and cutting the seed with a laser. See, e.g., U.S. Pat. No. 7,591,101; Day et al. Trends Plant Sci. 10:397 (2005); Nelson et al. Ann. Rev. Plant. Biol. 57:181 (2006).

In some embodiments, the portion of endosperm is removed from the seed in a manner that preserves the viability of the seed. In some such embodiments, viability is maintained for at least about six months after the portion of endosperm is removed. In some such embodiments, the seed is treated with a protective substance after the portion of endosperm is removed. The protective substance may comprise any substance that is known in the art for protecting a seed from environmental conditions, including, but not limited to, polymers and fungicides.

### Mass Spectrometry

The present invention provides methods of using mass spectrometry to identify and/or quantify a protein of interest in a sample derived from a portion of endosperm that has been removed from a seed. In general, such methods may be divided into two distinct categories based upon how the sample is prepared prior to performing mass spectrometry.

Methods that utilize proteolytic digestion generally comprise extracting one or more proteins from the sample, digesting the extracted protein(s), ionizing the resultant peptides, sorting the ionized peptides according to their mass-to-charge ration (m/z), detecting the ionized peptides and quantifying the protein of interest based upon the relative intensity of one or more peaks associated with one or more of the proteolytic peptides belonging to the protein of interest. Optionally, the protein of interest may, prior to digestion, be separated from some portion of the other proteins present in the sample.

In contrast, “top-down” methods do not require proteolytic digestion of the protein of interest prior to mass spectrometry analysis. Such “top-down” methods therefore allow for the analysis of the intact protein of interest.

Any present or future method of mass spectrometry known in the art may be utilized in the methods/systems of this invention, including, but not limited to, analyte separation techniques such as liquid chromatography (LC) and high-performance liquid chromatography (HPLC); ionization techniques such as electrospray ionization (ESI), desorption electrospray ionization (DESI), direct analysis in real time ionization (DART), matrix-assisted laser desorption/ionization (MALDI) and atmospheric pressure chemical ionization (APCI); fragmentation techniques such as electron transfer dissociation (ETD), electron capture dissociation (ECD), collision-induced dissociation (CID) and infrared multiphoton dissociation (IRMPD); and analyzers such as time-of-flight analyzers (TOF), quadruple mass analyzers, triple quadruple mass analyzers, quadruple ion traps, Fourier transform ion cyclotron resonance analyzers (FT-ICR) and Orbitraps. Exemplary protocols may be found, for example, in Bereman et al. Rapid Comm. Mass Spectrom. 20:3409 (2006), Cristoni et al. Rapid Comm. Mass Spectrom. 16:1686 (2002), Han et al. Science 314:109 (2006), Kubec et al. J. Ag. Food Chem. 58:1121 (2010), Lehmann et al. Plant J. 55:1039 (2008), Little et al. Anal. Chem. 66:2809 (1994), López et al. J. Chromatography 1216:7222 (2009), Mikesh et al. Biochim. Biophys. Acta 1764:1811 (2006), Schaff et al. J. Chromatography 886:89 (2007), Sheoran et al. Proteomics 5:3752 (2005) and Wienkoop et al. J. Exp. Biol. 59:3307 (2008).

Protein Extraction

Proteins (or fragments thereof) may be extracted from a sample by any present or future method known in the art, including, but not limited to, the methods described by Sheoran et al. (Plant Science 176:99 (2009)). The following are examples of extraction procedures that may be utilized to carry out the methods of this invention:

I. TCA-Acetone Extraction

A seed chip is ground to a fine powder in liquid nitrogen and extracted with acetone containing 10% (w/v) trichloroacetic acid (TCA) and 1% (w/v) DTT. The extracted sample is stored overnight at −20° C. and then centrifuged at 25,000×g for 20 min at 4° C. The resultant pellet is washed by suspension in acetone containing 1% (w/v) DTT for 1 hour at −20° C.

II. Phenol Extraction

A seed chip is ground to a fine powder in liquid nitrogen and extracted by further grinding the powder in 1 ml phenol (Tris pH 8.8 buffered) and 1 ml extraction buffer (0.1 M Tris-HCl pH 8.8, 5 mM EDTA, 20 mM DTT, 30% sucrose). The extracted sample is vortexed for 30 min at 4° C. prior to centrifugation at 25,000×g for 10 min at 4° C. Proteins from the phenol (upper) layer are precipitated by adding 5 volumes of 0.1 M ammonium acetate in 100% methanol at −20° C., vortexing and incubating −20° C. overnight prior to centrifugation at 25,000×g for 20 min at 4° C. The resultant pellet is washed twice with 0.1 M ammonium acetate in 100% methanol, twice with 80% acetone and once with 80% acetone containing 10 mM DTT.

III. SDS Extraction

A seed chip is ground to a fine powder and extracted in 225 mM Tris pH 6.9, 50% glycerol, 5% SDS and 250 mM DTT. The extracted sample is incubated for 5 min at 95° C., then centrifuged at 2,000×g for 15 min at room temperature. The resultant supernatant is collected.

IV. Tris-HCl Extraction

A seed chip is ground to a fine powder in liquid nitrogen and mixed with Tris-HCl buffer consisting of 50 mM Tris-HCl pH 8.8, 5 mM EDTA, 20 mM DTT, 100 mM KCl and 2 mM phenylmethylsulfonyl fluoride (PMSF). After thawing, the mixture is ground for an additional 30 min.

V. Tris-HCl Extraction and Precipitation

A seed chip is ground to a fine powder in liquid nitrogen and mixed with Tris-HCl buffer consisting of 50 mM Tris-HCl pH 8.8, 5 mM EDTA, 20 mM DTT, 100 mM KCl and 2 mM phenylmethylsulfonyl fluoride (PMSF). After thawing, the mixture is ground for an additional 30 mM at 4° C. prior to centrifugation at 25,000×g for 20 min at 4° C. Proteins from the supernatant are precipitated by adding 5 volumes of 100% acetone, vortexing and incubating at −20° C. for 2 hours prior to centrifugation. The resultant pellet is washed twice with 80% acetone.

VI. DESI “Extraction”

A charged solvent is electrosprayed at an angle onto the surface of a sample, causing ionized proteins or peptides to be released from the surface of the sample. In some embodiments, the surface of the sample is sprayed with a protease solution (e.g., a solution comprising trypsin) prior to being sprayed with the charged solvent. As one skilled in the art will understand, the composition of the charged solvent may vary, depending on the target protein(s) of interest. For example, the solvent may comprise methanol-water (1:1 containing 1% acetic acid) or acetonitrile-water (1:1 containing 0.1% formic acid).

Protein Separation

Extracted proteins may be separated by any present or future method known in the art, including, but not limited to, the methods described by Sheoran et al. (Proteomics 5:3752 (2005)). The following are examples of separation procedures that may be utilized to carry out the methods of this invention:

I. One-Dimensional (1-D) Electrophoresis

A sample comprising extracted proteins is mixed with an equal volume of SDS reducing buffer (2% SDS, 25% glycerol, 0.5% β-mercaptoethanol and 0.625 mM Tris-HCl pH 6.8) and separated by SDS-PAGE according to methods known to those in the art. See, e.g., Laemmli, Nature 227:680 (1970).

The gel is stained and analyzed. The gel may be stained using any known method, including, but not limited to, Coomassie Brilliant Blue (CBB) staining, silver staining and/or SYPRO® Ruby staining (Bio-Rad Laboratories, Inc., Hercules, Calif.). For example, the gel may be stained overnight with 0.25% CBB in a 5:1:4 methanol:acetic acid:water solution at 4° C. and destained with a 2:1:7 methanol:acetic acid:water solution at 4° C. Alternatively, the gel may be stained with 0.1% CBB in a 4:1:5 methanol:acetic acid:water solution and destained with a 4:1:5 methanol:acetic acid:water solution for 1 hour at room temperature. Silver staining may be performed according to any known method, including, but not limited to, the method described by Mortz et al. (Proteomics 1:1359 (2001)). SYPRO® Ruby staining may be performed overnight following fixation of the gel in a 1:0.7:8.3 methanol:acetic acid:water solution.

Any known method/apparatus may be used to analyze the gels, including, but not limited to, visually inspecting the gel to ascertain whether a spot/band corresponding to the protein of interest is present in the gel.

II. Two-Dimensional (2-D) Electrophoresis

A sample comprising extracted proteins is loaded onto an Immobiline™ DryStrip with a linear pH gradient of 4-7 or 3-10 (Amersham Biosciences, Uppsala, Sweden) using rehydration solution (8 M urea, 2% CHAPS, 20 mM DTT, 2% immobilized pH gradient buffer (pH 3-10) and 0.002% bromophenol blue) for 16 hours at 22° C. First dimension isoelectric focusing is performed using a Multiphor™ II horizontal electrophoresis system (GE Healthcare Life Sciences, Piscataway, N.J.), applying 250 V for 1 hour, ramping to 3,500 V over 2 hours, and holding at 3,500 V until a total of 75 kVh is attained.

Second dimension isoelectric focusing is performed using a Protean II XI multi-cell (Bio-Rad Laboratories, Inc., Hercules, Calif.). The strip is equilibrated for 15 min in equilibration buffer (6 M urea, 30% glycerol, 2% SDS, 50 mM Tris-HCl pH 8.8, 0.01% bromophenol blue and 10 mM DTT) followed by an additional 15 min in equilibration buffer containing 2% iodoacetamide. After equilibration, the strip is applied to a vertical SDS polyacrylamide gel (12% resolving and 5% stacking) and sealed with 0.5% low-melting agarose in SDS buffer containing bromophenol blue. Electrophoresis is performed for 30 min at 25 mA and 3.5 hours at 40 mA in electrophoresis buffer pH 8.3 (25 mM Tris base, 192 mM glycine and 0.1% SDS) at 10° C.

The gel is stained and analyzed. The gel may be stained using any known method, including, but not limited to, Coomassie Brilliant Blue (CBB) staining, silver staining and/or SYPRO® staining (Bio-Rad Laboratories, Inc., Hercules, Calif.). For example, the gel may be stained overnight with 0.25% CBB in a 5:1:4 methanol:acetic acid:water solution at 4° C. and destained with a 2:1:7 methanol:acetic acid:water solution at 4° C. Alternatively, the gel may be stained with 0.1% CBB in a 4:1:5 methanol:acetic acid:water solution and destained with a 4:1:5 methanol:acetic acid:water solution for 1 hour at room temperature. Silver staining may be performed according to any known method, including, but not limited to, the method described by Mortz et al. (Proteomics 1:1359 (2001)). SYPRO® Ruby staining may be performed overnight following fixation of the gel in a 1:0.7:8.3 methanol:acetic acid:water solution. Any known method/apparatus may be used to analyze the gels, including, but not limited to, Phoretix™ 2D (Nonlinear Dynamics Ltd., Newcastle upon Tyne, UK), Progenesis SameSpots (Nonlinear Dynamics Ltd., Newcastle upon Tyme, UK) or PDQuest™ (Bio-Rad Laboratories, Inc., Hercules, Calif.) image analysis software.

Protein Digestion

Extracted and/or separated proteins may be digested by any present or future method known in the art, including, but not limited to, the methods described by Sheoran et al, (Proteomics 5:3752 (2005)). The following are examples of digestion procedures that may be utilized to carry out the methods of this invention:

I. In-Gel Digestion

A spot/band corresponding to the protein of interest is excised from a stained gel, destained, reduced with DTT, alkylated and digested with a protease such as trypsin. The spot/band may be excised using any apparatus or system known in the art, including, but not limited to, a handheld razor blade, an X-Acto® knife (Elmer's Products, Inc., Columbus, Ohio) and a ProteomeWorks™ 2-D spot cutter (Bio-Rad Laboratories, Inc., Hercules, Calif.). The spot/band (and the protein(s) contained therein) may be destained, reduced, alkylated and digested using an automatic MassPREP digest station (Micromass, Manchester, UK).

II. In-Solution Digestion

Extracted proteins are digested with an enzyme in the absence of a gel-based separation protocol. The extracted proteins may be digested using a solution of trypsin.

III. DESI “Digestion”

A charged solvent is electrosprayed at an angle onto the surface of a sample, causing ionized peptides to be released from the surface of the sample. In some embodiments, the surface of the sample is sprayed with a protease solution (e.g., a solution comprising trypsin) prior to being sprayed with the charged solvent. As one skilled in the art will understand, the composition of the charged solvent may vary, depending on the target protein(s) of interest. For example, the solvent may comprise methanol-water (1:1 containing 1% acetic acid) or acetonitrile-water (1:1 containing 0.1% formic acid).

Protein Quantification

Proteins may be quantified using any present or future method known in the art, including, but not limited to, the methods described by Schaff et al. (J. Chromatography 886:89 (2007)), Wienkoop et al. (J. Exp. Biol. 59:3307 (2008)) and Zieske (J. Exp. Botany 57:1501 (2006)). The following are examples of quantification procedures that may be utilized to carry out the methods of this invention:

I. Comparison with Isotope-Labeled Peptide Standards

The protein of interest is quantified by comparing the relative intensity of a peak associated with a peptide of interest to that of a peak associated with an isotope-labeled peptide standard. A stable isotope-labeled peptide standard is synthesized, said standard being chemically identical to a peptide of interest. Any method known in the art may be used to identify a peptide of interest, including, but not limited to, the methods described by Kirsch et al. (Anal. Bioanal. Chem. 395(11):57 (2009)) and McKay et al. (Proteomics Clin. Appl. 1:1570 (2007)). The isotope-labeled peptide standard may be synthesized using any method known in the art, including, but not limited to, the AQUA approach described by Gerber et al. (PNAS USA 100:6940 (2003)). Other suitable approaches are described by Thelen and Peck (Cell 19:3339 (2007)). The isotope-labeled peptide standard is introduced in a known amount to the sample prior to digestion and/or ionization. The peptide of interest and the isotope-labeled peptide standard are detected using mass spectrometry. See, e.g., Lehmann et al., Plant J. 55:1039 (2008); Anderson and Hunter, Mol. Cell. Proteomics 5:573 (2006).

II. Comparison with a Non-Peptide Standard

The protein of interest is quantified by comparing the relative intensity of a peak associated with a peptide of interest to that of a peak associated with a known standard (e.g., cortisol). A peptide of interest may be identified using any method known in the art, including, but not limited to, the methods described by Kirsch et al. (Anal. Bioanal. Chem. 395(11):57 (2009)) and McKay et al. (Proteomics Clin. Appl. 1:1570 (2007)). A standard, such as cortisol, is introduced to the sample in a known amount prior to or during digestion/ionization/fragmentation.

III. Quantification Using Chemical Peptide Labeling

The protein of interest is quantified by comparing the relative intensity of a peak associated with a chemically-labeled peptide of interest in a sample derived from a first seed to that of the peak(s) associated with a chemically-labeled peptide of interest in a sample(s) derived from one or more other seeds, wherein the peptide of interest in the sample(s) derived from the one or more other seeds is chemically identical to the peptide of interest in the sample from the first seed. The peptides of interest in each sample are labeled with different chemical labels (i.e., the peptide of interest in the sample derived from the first seed possesses a different label than the peptide of interest in the sample(s) derived from the one or more other seeds) and the samples are mixed and analyzed together using mass spectrometry. Any method known in the art may be used to chemically-label the peptides of interest, including, but not limited to, the methods described by Zieske (J. Exp. Botany 57:1501 (2006)). For example, the peptide of interest may be chemically-labeled using Isobaric Tags for Relative and Absolute Quantitation (iTRAQ), Tandem Mass Tags (TMT) or Isotope-coded Affinity Tags (iCAT).

IV. Label-Free Quantification

The protein of interest is quantified by comparing the relative intensity of a peak associated with a peptide of interest in a sample derived from a first seed to that of peaks associated with the peptide of interest in samples derived from one or more other seeds (e.g., a second seed, a third seed, a fourth seed, etc.). The peptides of interest in each sample are compared in the absence of any standard or internal reference. In some embodiments, the peptide of interest is analyzed using selected ion monitoring (SIM), selected reaction monitoring (SRM) or multiple reaction monitoring (MRM).

### Zygosity

The zygosity of a seed with regard to an allele of interest may be determined by analyzing the amount of a protein of interest in a sample derived from a portion of endosperm that has been removed from the seed.

In some embodiments, the amount of the protein of interest in the sample derived from the portion of endosperm is compared to a reference value(s). The reference value(s) may be associated with:
1. the amount of the protein of interest in a sample derived from a portion of endosperm removed from the endosperm of a reference seed that is homozygous for the allele of interest;
2. the amount of the protein of interest in a sample derived from a portion of endosperm removed from the endosperm of a reference seed that is heterozygous for the allele of interest;
3. the amount of the protein of interest in a sample derived from a portion of endosperm removed from the endosperm of a reference seed that does not comprise the allele of interest;
4. the amount of the protein of interest in a sample derived from a portion of endosperm removed from the endosperm of a reference seed that does not comprise a functional allele of interest;
5. the average amount of the protein of interest in samples derived from portions of endosperm removed from reference seeds that are homozygous for the allele of interest;
6. the average amount of the protein of interest in samples derived from portions of endosperm removed from reference seeds that are heterozygous for the allele of interest;
7. the average amount of the protein of interest in samples derived from portions of endosperm removed from reference seeds that do not comprise the allele of interest; and/or
8. the average amount of the protein of interest in samples derived from portions of endosperm removed from reference seeds that do not comprise a functional allele of interest.

In some embodiments, the amount of the protein of interest in the sample derived from the portion of endosperm from the seed, which is a first seed, is compared to the amount of the protein of interest in a sample derived from a portion of endosperm that has been removed from a second seed and/or the amount of the protein of interest in a sample derived from a portion of endosperm that has been removed from a third seed. In some such embodiments, the three seeds are progeny of the same parents.

In some embodiments, it is determined that a seed is homozygous for an allele of interest if the amount of a protein of interest in a sample derived from a portion of endosperm that has been removed from the seed, which is a first seed, is:
1. substantially equal to a reference value associated with the amount of the protein of interest in a sample derived from a portion of endosperm removed from the endosperm of a reference seed that is homozygous for the allele of interest;
2. substantially equal to a reference value associated with the average amount of the protein of interest in samples derived from portions of endosperm removed from reference seeds that are homozygous for the allele of interest;
3. at least about twice that of a reference value associated with the amount of the protein of interest in a sample derived from a portion of endosperm removed from the endosperm of a reference seed that is heterozygous for the allele of interest;
4. at least about twice that of a reference value associated with the average amount of the protein of interest in samples derived from portions of endosperm removed from reference seeds that are heterozygous for the allele of interest; or
5. at least about twice the amount of the protein of interest in a sample derived from a portion of endosperm that has been removed from a second seed.

In some embodiments, it is determined that a seed is heterozygous for an allele of interest if the amount of a protein of interest in a sample derived from a portion of endosperm that has been removed from the seed, which is a first seed, is:
1. about half that of a reference value associated with the amount of the protein of interest in a sample derived from a portion of endosperm removed from the endosperm of a reference seed that is homozygous for the allele of interest;
2. about half that of a reference value associated with the average amount of the protein of interest in samples derived from portions of endosperm removed from reference seeds that are homozygous for the allele of interest;
3. substantially equal to a reference value associated with the amount of the protein of interest in a sample derived from a portion of endosperm removed from the endosperm of a reference seed that is heterozygous for the allele of interest;
4. substantially equal to a reference value associated with the average amount of the protein of interest in samples derived from portions of endosperm removed from reference seeds that are heterozygous for the allele of interest; or
5. about half the amount of the protein of interest in a sample derived from a portion of endosperm that has been removed from a second seed.

In some embodiments, it is determined that a seed is homozygous for an allele of interest if the amount of a protein of interest in a sample derived from a portion of endosperm that has been removed from the seed is:
1. substantially equal to a reference value associated with the amount of the protein of interest in a sample derived from a portion of endosperm removed from the endosperm of a reference seed that does not comprise the allele of interest;
2. substantially equal to a reference value associated with the average amount of the protein of interest in samples derived from portions of endosperm removed from reference seeds that do not comprise the allele of interest;
3. substantially equal to a reference value associated with the amount of the protein of interest in a sample derived from a portion of endosperm removed from the endosperm of a reference seed that does not comprise a functional form of the allele of interest; or
4. substantially equal to a reference value associated with the average amount of the protein of interest in samples derived from portions of endosperm removed from reference seeds that do not comprise a functional form of the allele of interest.
   In some such embodiments, at least one of the desired traits associated with the allele of interest is a reduction or elimination of the protein of interest or of a detectable amount of the protein of interest.

In some embodiments, it can be determined that a seed is homozygous for an allele of interest because a sample derived from a portion of endosperm that has been removed from the seed contains a detectable amount of a protein of interest. In such embodiments, at least one of the desired traits associated with the allele of interest is the presence of the protein of interest or of a detectable amount of the protein of interest. In some such embodiments, the protein of interest is only produced if the seed is homozygous for the allele of interest.

In some embodiments, it can be determined that a seed is homozygous for an allele of interest because there is no detectable amount of a protein of interest in a sample derived from a portion of endosperm that has been removed from the seed. In such embodiments, at least one of the desired traits associated with the allele of interest is the absence of the protein of interest or of a detectable amount of the protein of interest. In some such embodiments, the protein of interest would be present in detectable amounts unless the seed is homozygous for the allele of interest.

### Predicting Possession of a Desired Trait

Whether a seed is likely to produce a plant possessing a desired trait may be determined by analyzing the amount of a protein of interest in a sample derived from a portion of endosperm that has been removed from the seed.

In some embodiments, the amount of the protein of interest is compared to a reference value(s). The reference value(s) may be associated with:
1. the amount of the protein of interest in a sample derived from a portion of endosperm removed from the endosperm of a reference seed that produced a plant possessing the desired trait;
2. the amount of the protein of interest in a sample derived from a portion of endosperm removed from the endosperm of a reference seed that produced a plant lacking the desired trait;
3. the average amount of the protein of interest in samples derived from portions of endosperm removed from reference seeds that produced plants possessing the desired trait; and/or
4. the average amount of the protein of interest in samples derived from portions of endosperm removed from reference seeds that produced plants lacking the desired trait.

In some embodiments, the amount of the protein of interest in the sample derived from the portion of endosperm from the seed, which is a first seed, is compared to the amount of the protein of interest in a sample derived from a portion of endosperm that has been removed from a second seed. In some such embodiments, the two seeds are progeny of the same parents.

In some embodiments, it can be determined that a seed is likely to produce a plant possessing a desired trait associated with enhanced production of the protein of interest if the amount of a protein of interest in a sample derived from a portion of endosperm that has been removed from the seed, which is a first seed, is:
1. substantially equal to a reference value associated with the amount of the protein of interest in a sample derived from a portion of endosperm removed from the endosperm of a reference seed that produced a plant possessing the desired trait;
2. substantially equal to a reference value associated with the average amount of the protein of interest in samples derived from portions of endosperm removed from seeds that produced plants possessing the desired trait;
3. significantly greater than a reference value associated with the amount of the protein of interest in a sample derived from a portion of endosperm removed from the endosperm of a reference seed that produced a plant lacking the desired trait;
4. significantly greater than a reference value associated with the average amount of the protein of interest in samples derived from portions of endosperm removed from seeds that produced plants lacking the desired trait;
5. at least about twice that of a reference value associated with the amount of the protein of interest in a sample derived from a portion of endosperm removed from the endosperm of a reference seed that produced a plant lacking the desired trait;
6. at least about twice that of a reference value associated with the average amount of the protein of interest in samples derived from portions of endosperm removed from seeds that produced plants lacking the desired trait;
7. substantially equal to or greater than the amount of the protein of interest in a sample derived from a portion of endosperm removed from a second seed;
8. at least about twice the amount of the protein of interest in a sample derived from a portion of endosperm removed from a second seed; and/or
9. a nonzero amount.

In some embodiments, it can be determined that a seed is likely to produce a plant possessing a desired trait associated with reduced production of the protein of interest if the amount of a protein of interest in a sample derived from a portion of endosperm that has been removed from the seed, which is a first seed, is:
1. substantially equal to a reference value associated with the amount of the protein of interest in a sample derived from a portion of endosperm removed from the endosperm of a reference seed that produced a plant possessing the desired trait;
2. substantially equal to a reference value associated with the average amount of the protein of interest in samples derived from portions of endosperm removed from seeds that produced plants possessing the desired trait;
3. significantly less than a reference value associated with the amount of the protein of interest in a sample derived from a portion of endosperm removed from the endosperm of a reference seed that produced a plant lacking the desired trait;
4. significantly less than a reference value associated with the average amount of the protein of interest in samples derived from portions of endosperm removed from seeds that produced plants lacking the desired trait;
5. at least about half that of a reference value associated with the amount of the protein of interest in a sample derived from a portion of endosperm removed from the endosperm of a reference seed that produced a plant lacking the desired trait;
6. at least about half that of a reference value associated with the average amount of the protein of interest in samples derived from portions of endosperm removed from seeds that produced plants lacking the desired trait;
7. substantially equal to or less than the amount of the protein of interest in a sample derived from a portion of endosperm removed from a second seed;
8. at least about half the amount of the protein of interest in a sample derived from a portion of endosperm removed from a second seed;
9. negligible; and/or
10. not detectable.

In some embodiments, it is determined that a seed is likely to produce a plant possessing the desired trait because a sample derived from a portion of endosperm that has been removed from the seed contains a detectable amount of a protein of interest. In such embodiments, the desired trait is associated with the presence of the protein of interest. In some such embodiments, samples derived from portions of endosperm removed from seeds that are likely to produce plants possessing the desired trait comprise a detectable amount of the protein of interest.

In some embodiments, it can be determined that a seed is likely to produce a plant possessing the desired trait because there is no detectable amount of a protein of interest in a sample derived from a portion of endosperm that has been removed from the seed. In such embodiments, the desired trait is associated with the absence of the protein of interest. In some such embodiments, the protein of interest is never present in detectable amounts in samples derived from portions of endosperm removed from seeds that are likely to produce plants possessing the desired trait.

The following non-limiting examples are provided to further illustrate the present invention.

### EXAMPLES

The following examples are not intended to be a detailed catalog of all the different ways in which the present invention may be implemented or of all the features that may be added to the present invention. Persons skilled in the art will appreciate that numerous variations and additions to the various embodiments may be made without departing from the present invention. Hence, the following descriptions are intended to illustrate some particular embodiments of the invention, and not to exhaustively specify all permutations, combinations and variations thereof.

### Example 1

### Producing Plants that are Homozygous for an Allele of Interest: Quantification Using Isotope-Labeled Standards

A portion of endosperm is removed from each of a plurality of maize seeds—some of which are homozygous for an allele of interest, some of which are heterozygous for the allele of interest, some of which do not comprise the allele of interest and some of which do not comprise the allele of interest in a functional form—such that the seeds remain viable after the portion of endosperm is removed. Protein extraction is carried out on a sample derived from each portion of endosperm and the extracted proteins are digested with trypsin. A known amount of an isotope-labeled standard that is chemically identical to a proteolytic peptide associated with a protein of interest is added to each of the samples. The samples (including the isotope-labeled standards) are analyzed using a liquid chromatography triple-stage quadruple mass spectrometer. The protein of interest in each sample (if present) is quantified by comparing the relative intensity of the peak associated with its proteolytic peptide to that of the peak associated with the isotope-labeled standard.

The samples are divided into three categories based upon the presence or absence of a detectable amount of the protein of interest and the amount of the protein of interest (if detectable). The samples in the first category contain no detectable amount of the protein of interest. The samples in the second category contain a detectable amount of the protein of interest that is about ×ng. The samples in the third category contain a detectable amount of the protein of interest that is at least about 2×ng.

Seeds from which the samples in the first category are derived are identified as either lacking the allele of interest or as lacking the allele of interest in a functional form.

Seeds from which the samples in the second category are derived are identified as being heterozygous for the allele of interest.

Seeds from which the samples in the third category are derived are identified as being homozygous for the allele of interest.

Plants are grown using seeds from which samples in the third category are derived.

### Example 2

### Producing Plants that are Homozygous for an Allele of Interest: Label-Free Quantification

A portion of endosperm is removed from each of a plurality of maize seeds—some of which are homozygous for an allele of interest, some of which are heterozygous for the allele of interest, some of which do not comprise the allele of interest and some of which do not comprise the allele of interest in a functional form—such that the seeds remain viable after the portion of endosperm is removed. Protein extraction is carried out on a sample derived from each portion of endosperm and the extracted proteins are digested with trypsin. Each sample is analyzed using an electrospray ionization mass spectrometer. The intensity of the peak(s) associated with one or more proteolytic peptides belonging to the protein of interest is recorded for each sample. The protein of interest in each sample (if present) is quantified by comparing the intensity of the peak(s) associated with the proteolytic peptide(s) belonging to the protein of interest in one sample with the intensity of the peak(s) associated with the proteolytic peptide(s) belonging to the protein of interest in one or more other samples.

The samples are divided into three categories based upon the presence or absence of a detectable amount of the protein of interest and the amount of the protein of interest (if detectable). The samples in the first category contain no detectable amount of the protein of interest. The samples in the second category contain a detectable amount of the protein of interest that is substantially equal to a reference value associated with a seed that is heterozygous for the allele of interest and/or is at least about half that of a reference value associated with a seed that is homozygous for the allele of interest. The samples in the third category contain a detectable amount of the protein of interest that is substantially equal to a reference value associated with a seed that is homozygous for the allele of interest and/or is at least about twice that of a reference value associated with a seed that is heterozygous for the allele of interest.

Seeds from which the samples in the first category are derived are identified as lacking the allele of interest or as lacking the allele of interest in a functional form.

Seeds from which the samples in the second category are derived are identified as being heterozygous for the allele of interest.

Seeds from which the samples in the third category are derived are identified as being homozygous for the allele of interest.

Plants are grown using seeds from which samples in the third category are derived.

### Example 3

### Producing Plants that are Homozygous for Multiple Alleles of Interest: Multiple Transgenic Events

A portion of endosperm is removed from each of a plurality of seeds such that the seeds remain viable after the portion of endosperm is removed, wherein each of the seeds is derived from a plant that has been transformed according to well known methods (e.g., via Agrobacterium) such that it contains a plurality of transgenes, each of which comprises an allele of interest. The transgenes may have been introduced into the plant together (e.g., via a single transformation wherein multiple transgenes were part of a single construct) or separately (e.g., via multiple transformations wherein multiple constructs were used to introduce the transgenes into the plant), or any combination thereof. A sample is derived from each portion of endosperm, and the amount of each of a plurality of proteins of interest—each of which is associated with an allele of interest—is quantified using mass spectrometry.

The samples are divided into various categories based upon the amount of each of the proteins of interest in each sample. For example, samples in one category may contain no detectable amount of any of the proteins of interest. Samples in another category may contain a detectable amount of each of the proteins of interest. Samples in yet another category may contain no detectable amount of one protein of interest, but may contain a detectable amount of another protein of interest, in any combination. The zygosity of each seed is determined with regard to each allele of interest based upon the amount of the protein of interest associated with that allele (as described above).

Plants are grown using seeds that are identified as being homozygous for some or all of the alleles of interest.

### Example 4

### Producing Plants that Possess a Desired Trait: Quantification Using Isotope-Labeled Standards

A portion of endosperm is removed from each of a plurality of maize seeds—some of which are likely to produce a plant possessing a desired trait and some of which are likely to produce a plant lacking the desired trait—such that the seeds remain viable after the portion of endosperm is removed. The desired trait is associated with enhanced production of the protein of interest. Protein extraction is carried out on a sample derived from each portion of endosperm and the extracted proteins are digested with trypsin. A known amount of an isotope-labeled standard that is chemically identical to a proteolytic peptide associated with a protein of interest is added to the samples. The samples (including the isotope-labeled standards) are analyzed using a liquid chromatography triple-stage quadruple mass spectrometer. The protein of interest in each sample (if present) is quantified by comparing the relative intensity of the peak associated with its proteolytic peptide to that of the peak associated with the isotope-labeled standard.

The samples are divided into two categories based upon the amount of the protein of interest in each sample. The samples in the first category contain an amount of the protein of interest that is substantially equal to a reference value associated with a seed that produced a plant lacking the desired trait and/or is significantly less than a reference value associated with a seed that produced a plant possessing the desired trait. The samples in the second category contain an amount of the protein of interest that is substantially equal to a reference value associated with a seed that produced a plant possessing the desired trait and/or is significantly greater than a reference value associated with a seed that produced a plant lacking the desired trait.

Seeds from which the samples in the first category are derived are identified as being likely to produce plants lacking the desired trait.

Seeds from which the samples in the second category are derived are identified as being likely to produce plants possessing the desired trait.

Plants are grown using seeds from which samples in the second category are derived.

That which is claimed:

1. A method of identifying a seed that is homozygous for an allele of interest, comprising:
(a) removing a portion of endosperm from the seed;
(b) quantifying a protein of interest in a sample derived from the portion of endosperm using mass spectrometry; and
(c) determining that the seed is homozygous for the allele of interest.

2. The method of claim 1, wherein the seed remains viable after the portion of endosperm is removed.

3. A method of producing a plant that is homozygous for an allele of interest, comprising:
(a) removing a portion of endosperm from a seed such that the seed remains viable after the portion of endosperm is removed;
(b) quantifying a protein of interest in a sample derived from the portion of endosperm using mass spectrometry;
(c) determining that the seed is homozygous for the allele of interest; and
(d) growing a plant from the seed, thereby producing a plant that is homozygous for the allele of interest.

4. The method of claim 1, wherein step (b) comprises comparing the relative intensity of a peak associated with the peptide of interest to that of a peak associated with a known amount of a standard.

5. The method of claim 4, wherein said standard is an isotope-labeled peptide that is chemically identical to the peptide of interest.

6. The method of claim 1, wherein step (b) comprises comparing the amount of the protein of interest in the sample derived from the portion of endosperm from the seed, which is a first seed, with the amount of the protein of interest in a sample derived from a portion of endosperm from a second seed.

7. The method of claim 1, wherein step (c) comprises determining that the amount of the protein of interest in the sample from the portion of endosperm from the seed, which is a first seed, is at least about twice that of a sample from a second seed.

8. The method of claim 7, wherein step (c) further comprises determining that a sample from a third seed contains no detectable amount of the protein of interest.

9. The method of claim 8, wherein the first seed, the second seed and the third seed are progeny of the same parents.

10. The method of claim 8, further comprising determining that the second seed is heterozygous for the allele of interest, determining that the third seed does not comprise the allele of interest, and/or determining that the third seed does not comprise the allele of interest in a functional form.

11. The method of claim 1, wherein step (c) comprises determining that the sample derived from the portion of endosperm from the seed contains a detectable amount of the protein of interest.

12. The method of claim 1, wherein step (c) comprises determining that the sample derived from the portion of endosperm from the seed contains no detectable amount of the protein of interest.

13. The method of claim 1, wherein step (c) comprises comparing the amount of the protein of interest in the sample derived from the portion of endosperm from the seed to a reference value.

14. A system for identifying a seed that is homozygous for an allele of interest, comprising:
(a) a means for removing a portion of endosperm from the seed; and
(b) a means for quantifying a protein of interest in a sample derived from the portion of endosperm using mass spectrometry.

15. The system of claim 14, wherein the seed remains viable after the portion of endosperm is removed.

16. The system of claim 15, further comprising a means for growing a plant from the seed, thereby growing a plant that is homozygous for the allele of interest.

17. A method of identifying a seed that is likely to produce a plant possessing a desired trait, comprising:
(a) removing a portion of endosperm from the seed;
(b) quantifying a protein of interest in a sample derived from the portion of endosperm using mass spectrometry; and
(c) determining that the seed is likely to produce a plant possessing the desired trait.

18. The method of claim 17, wherein the seed remains viable after the portion of endosperm is removed.

19. A method of producing a plant that possesses a desired trait, comprising:
(a) removing a portion of endosperm from a seed such that the seed remains viable after the portion of endosperm is removed;
(b) quantifying a protein of interest in a sample derived from the portion of endosperm using mass spectrometry;
(c) determining that the seed is likely to produce a plant possessing the desired trait; and
(d) growing a plant from the seed, thereby producing a plant that possesses the desired trait.

20. The method of claim 17, wherein step (b) comprises comparing the relative intensity of a peak associated with the peptide of interest to that of a peak associated with a known amount of a standard.

21. The method of claim 20, wherein said standard is an isotope-labeled peptide that is chemically identical to the peptide of interest.

22. The method of claim 17, wherein step (b) comprises comparing the amount of a protein of interest in the sample derived from the portion of endosperm from the seed, which is a first seed, with the amount of the protein of interest in a sample derived from a portion of endosperm from a second seed.

23. The method of claim 17, wherein step (c) comprises determining that the sample derived from the portion of endosperm from the seed contains a detectable amount of the protein of interest.

24. The method of claim 17, wherein step (c) comprises determining that the sample derived from the portion of endosperm from the seed contains no detectable amount of the protein of interest.

25. The method of claim 17, wherein step (c) comprises comparing the amount of the protein of interest in the sample derived from the portion of endosperm from the seed to a reference value,

26. A system for identifying a seed that is likely to produce a plant possessing a desired trait, comprising:
(a) a means for removing a portion of endosperm from the seed; and
(b) a means for quantifying a protein of interest in a sample derived from the portion of endosperm using mass spectrometry.

27. The system of claim 26, wherein the seed remains viable after the portion of endosperm is removed.

28. The system of claim 27, further comprising a means for growing a plant from the seed, thereby growing a plant that is likely to possess the desired trait.
